(19) United States
(12) Patent Application Publication
(10) Pub. No.: US 2006/0156300 A1
(43) Pub. Date: Jul. 13, 2006

(54) Vouching an authorized copy

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/548,216

(22) PCT Filed: Feb. 25, 2004
(86) PCT No.: PCT/IB04/00560

§ 371 Date: Sep. 2, 2005

Related U.S. Application Data
(60) Provisional application No. 60/451,912, filed on Mar. 4, 2003.
(60) Provisional application No. 60/483,766, filed on Jun. 30, 2003.

(51) Int. Cl. G06F 9/44

(52) U.S. Cl. 717/170; 717/122

(57) ABSTRACT

A vouching system and method provides an alternative means for authorizing access to protected content material. When a copy of content material (201) is deemed to be unauthorized by a rendering device (200), authorization can be obtained by contacting the source (100) of the copied material. If the copy (201) had been authorized, the source (100) re-certifies, or vouches for, the copy (201) to the rendering device (200). Upon receipt of this vouching, the rendering device (200) withdraws its rejection, and proceeds accordingly. Optionally, limits and security measures can be applied to this vouching process to minimize the potential for abuse.

This application claims the benefit of U.S. Provisional Patent Application 60/451,912, filed on 4 Mar. 2003.

This invention relates to the field of copy protection systems, and in particular to a system and method for providing access to a copy of protected content material by vouching for its authorization.

Copy protection provides the owner of copyright material, such as entertainment material, from unauthorized distribution of the material. Purchasers of copyright material, however, expect to be able to copy the purchased material for their own benefit or enjoyment. Standards and techniques continue to evolve to provide copy protection systems that allow purchasers of protected material to freely copy the material, yet still provide the owner of the protected material some protection from widescale distribution.

Of particular concern to owners of copyright material is the potential of widescale distribution of the material via the Internet. Heretofore, individuals had limited opportunity to widely distribute material, and legal recourse could be pursued against the relatively few widescale purveyors of illicit copies of copyright material. Augmenting the inherent widescale connectivity provided by the Internet, web-sites have been established to specifically facilitate the widescale distribution of entertainment material.

A variety of protection schemes have been proposed and/or implemented that attempt to balance the competing rights of the purchasers and owners of copyright material. A common technique used in many of these protection schemes is the use of a marking of the material that is sensitive to a change to the content material. For example, a mark can be created that is based on a hash value of the authorized content material. If the content is modified in any way, the mark will no longer correspond to a hash value of the modified content. By indelibly bonding the mark to the content material, via, for example, an electronic watermarking process, modified copies of the content material can be detected. Such a marking is particularly effective in detecting an Internet-distribution of the material, because the compression techniques that are commonly used to efficiently transmit information over the Internet introduce changes to the material.

An inherent problem with systems that attempt to verify the authorization of a copy of content material is that an error in the authorization process, could deprive a purchaser of the content material of the use of legitimately made copies. For example, a mis-read of the aforementioned hash mark or any bit of the content material, caused by noise, or faults in the media, and so on, can cause an authorized copy to be rejected as unauthorized. Additionally, the assumptions made in protection schemes, such as an assumption that all Internet transmissions of content material are unauthorized, can also deprive a purchaser of the content material of the legitimate use of copies. For example, the aforementioned Internet-transmission-detection scheme prevents a purchaser of a CD from sending a copy of the purchased material from the purchaser's home entertainment system to the purchaser's Internet-enabled car audio system via an Internet connection.

It is an object of this invention to provide a system and method that augments copy-protection schemes to minimize the effects of erroneous rejections of copied content material. It is a further object of this invention to provide a system and method that facilitates the legitimate copying of content material via the Internet.

These objects and others are achieved by a vouching system and method that provides an alternative means for authorizing access to protected content material. When a copy of content material is deemed to be unauthorized by a rendering device, authorization can be obtained by contacting the source of the copied material. If the copy had been authorized, the source recertifies, or vouches for, the copy to the rendering device. Upon receipt of this vouching, the rendering device withdraws its rejection, and proceeds accordingly. Optionally, limits and security measures can be applied to this vouching process to minimize the potential for abuse.

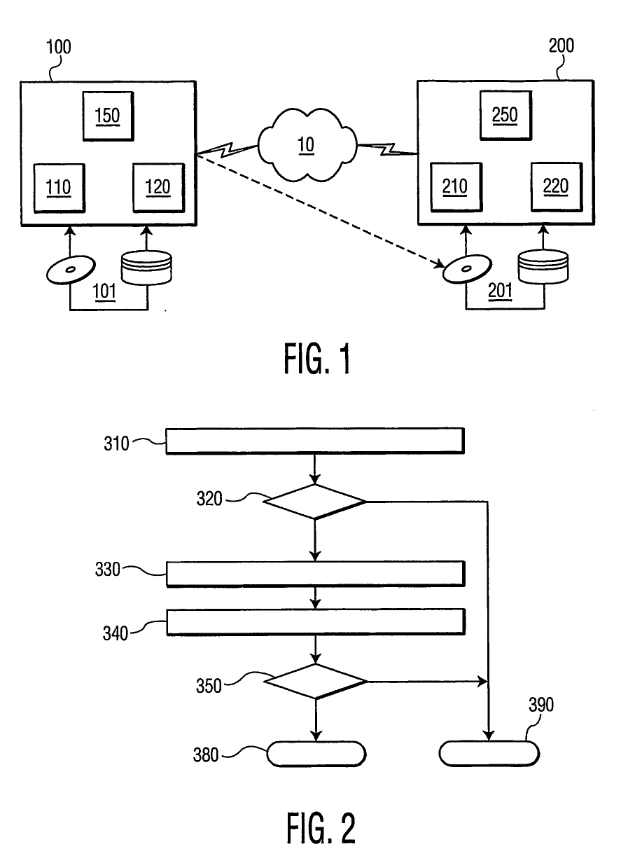

FIG. 1 illustrates an example block diagram of a copy protection system in accordance with this invention.

FIG. 2 illustrates an example flow diagram of a copy protection system in accordance with this invention.

Throughout the drawings, the same reference numeral refers to the same element, or an element that performs substantially the same function.

FIG. 1 illustrates an example block diagram of a copy protection system in accordance with this invention. The system includes a source 100 and a destination 200 system that are each configured to render authorized content material. The term ‘render’ is used herein to include playback, record, copy, display, or otherwise process content material.

Each of the systems 100, 200 are illustrated as comprising a rendering module 150, 250, an authorization module 110, 210, and a vouching module 120, 220. The corresponding modules in each system 100, 200 need not be identical, and, as detailed further below, may each provide different functions, based on whether the module is being used in a source or destination system.

The source system 100 is configured to access content material 101, which may be stored on a CD, DVD, magnetic disk, or other storage media. The authorization module 110 determines whether the content material 101 is authorized for rendering. Any of a variety of techniques may be used to provide this authorization function. U.S. Pat. No. 6,314,518, “SYSTEM FOR TRANSFERRING CONTENT INFORMATION AND SUPPLEMENTAL INFORMATION RELATING THERETO”, issued Nov. 6, 2001 to Johann P. M. G. Linnartz, for example, presents a technique for the protection of copyright material via the use of a watermark “ticket” that controls the number of times the protected material may be rendered, and is incorporated by reference herein. Copending U.S. patent application “PROTECTING CONTENT FROM ILLICIT REPRODUCTION BY PROOF OF EXISTENCE OF A COMPLETE DATA SET VIA SELF-REFERENCING SECTIONS”, U.S. Ser. No. 09/536,944, filed Mar. 28, 2000 for Antonius A. M. Staring, Michael A. Epstein, and Martin Rosner, Attorney Docket US000040, incorporated by reference herein, addresses the illicit distribution of select content material from a collection of copy protected content material, such as a song that is “ripped” from an album, by testing to assure that the entire collection is accessible at the rendering device. International Patent Application PCT/US00/15671 “METHOD AND SYSTEMS FOR PROTECTING DATA USING DIGITAL SIGNATURE AND WATERMARK”, published as WO 00/75925 on Dec. 14, 2000, and incorporated by reference herein, teaches a method and system that watermarks each segment of a disk based on a hash of the contents of a prior segment of the disk. If the contents are modified, via for example, a compression for transmission via the Internet, the watermarks will no longer correspond to a hash of the modified content. Other verification and authorization techniques are common in the art.

If the content material is determined to be authorized, the authorization module 110 enables the rendering module 150 to perform, or continue to perform, its intended function. One of the functions of the rendering module 150 includes creating a copy of the content material. This copy of the content material is communicated to the receiving system 200, and is illustrated as content material 201. This copy may be communicated via a network 10, such as the Internet, or via a physical media, as illustrated by the dashed arrow from the source 100 in FIG. 1. That is, the copied material 201 may be located on a CD, DVD, magnetic disk, or any other storage device that is accessible by the receiving system 200.

The receiving system 200 includes an authorization module 210 that verifies the authorization to render the copied material 201. As in the authorization module 110, the authorization module 210 may use any of a variety of techniques to verify the authority to render the copied material 201. These may include the same or different verification techniques as those in the module 110, depending upon the technique used by the source system 100 to identify the authorization. U.S. patent application 2001/0044899 A1, “TRANSMARKING OF MULTIMEDIA SIGNALS”, published Nov. 22, 2001, teaches the marking/re-marking of copied material each time it enters a new environment, to adapt the watermark to the robustness and perceptibility constraints of the new environment, and is incorporated by reference herein. Thus, if the original content material 101 was located on a magnetic disk, and was copied to a DVD disk 201, the source system 100 would be configured to apply a protective marking that is suitable for embodiment on a DVD disk 201, which may differ from the type of protective marking that was used to identify the authorization of the material 101.

If the authorization to render the copied material 201 is verified, the authorization module 210 enables the rendering device 250 to perform, or continue to perform, its intended function.

In accordance with this invention, if the authorization to render the copied material 201 is not verified, the user is provided the option of having the source system 100 vouch for the authorization to render the copied material 201, via the vouching modules 120, 220. This option may be a default ‘automatic’ response to a non-verification by the authorization module 210, or it may require user intervention, including, for example, an identification of the source system 100, if that information is not provided on the copied material 201. When invoked, the vouching module 220 of the receiving system contacts the vouching module 120 of the source system 100 and requests verification of the authorization to render the copied material 201. If the vouching module 120 provides the necessary verification, the vouching module 120 overrides the non-verification result of the authorization module 210, either by notifying the module 210, or by directly enabling the rendering module 250. That is, for example, the enabling signal to the rendering module 250 may be an OR function of an authorization from the authorization module 210 or from the vouching module 220. In this manner, a fault in the routine authorization process for authorizing the material 201 at the receiving system 200 can be corrected by this vouching process.

Depending upon the level of security desired, this vouching process may be as simple as a verification that the identified copy 201 was, in fact, created by the source system 100, or it may be as complex as requiring the source system 100 to prove that it is in possession of the source material 101. One of ordinary skill in the art will be able to devise a vouching system for affirming or denying the authorization to render a copy of content material in view of this disclosure, using techniques common in the art.

In a straightforward embodiment for relatively high security, the vouching modules 120, 220 could be configured to couple the authorization module 210 to the source material 101, so that the authorization module 210 could directly verify the authorization associated with the source material 101, and deduce therefrom the appropriate authorization of the copied material 201. For example, if the authorization module 210 determines that the source material 101 has a “play always, copy never” authorization, it is immediately apparent that the copy 201 is not authorized for rendering. To facilitate this verification of the source material 101, the authorization module 110 may be coupled to the authorization module 210 to effect some of the more time-consuming tasks required for this verification, such as the reading of the material 101 to determine hash values and the like.

In a simpler, albeit less secure embodiment, the source system 100 marks the copy 201 with a particular identifier that serves to verify that the source system 100 is the true source of the copy, such as a public key of a public-private key pair and an identifier of the copy 201. When queried by the vouching module 220, the vouching module 220 transmits the identifier to the source system 100, and the vouching module 120 returns an encryption of the identifier using its private key. The vouching module decrypts the encrypted identifier, and if it matches the identifier, the source system 100 is authenticated. The vouching module 120 only returns the encrypted identifier if the identifier is recognized as a copy having an authorization for the intended rendering at the system 200. In this way, the copy is verified as being authorized for rendering only by the source system 100, and only if the source system 100 recognizes the copy 201 as being authorized.

Other methods of verifying the vouching, with differing levels of security, will be evident to one of ordinary skill in the art in view of this disclosure. For example, the source system 100 and destination system 200 may use public key cryptography via vouching modules 120 and 220 to mutually authenticate each other. Following authentication, the public keys system is used to derive a shared encryption key. Thereafter, the source 100 can encrypt some or all of the source content material 101 and transmit it to the destination 200 as proof that the source 100 is in possession of the material 101.

One of ordinary skill in the art will recognize that different security measures and techniques have different vulnerabilities to attack and abuse. In this context, an attack is a scheme that allows a bogus system to appear to be the true source, and an abuse is the use of a valid source to facilitate unauthorized copying. The choice of the particular method used to effect the vouching process will be dependent upon the level of security desired to avoid an attack on the system. Additionally, limits can be imposed on the number of times a compliant source can vouch for each copy to limit abuse of the vouching process.

FIG. 2 illustrates an example flow diagram of a copy protection system in accordance with this invention. At 310, a rendering system attempts to verify the authorization to render a copy of content material, using any of a variety of techniques, depending upon the protection scheme provided in the content material and in the rendering system. If, at 320, the authorization is verified, the rendering system accepts the content material, at 390, and renders the material, or, if the rendering system has already commenced rendering the material, continues to render it.

If the authorization is unsuccessful, at 320, the source of the copy of the material is contacted, at 330. In a preferred embodiment of this invention, the copy of the material includes an identification of its source and/or an identification of a means to contact the source. For example, the copied material may include a URL address, or e-mail address associated with the source, and the receiving system contacts the source via the Internet. Alternatively, a manual process may be used to connect the rendering system to the source system to effect a vouching.

At 340, the rendering system receives information from the source that is intended to vouch for the authorization to render the copied material. As noted above, any of a variety of techniques, common in the art, can be used to verify the source of the copy and receive a vouching of the rendering authorization in view of this disclosure. If, at 350, the source system vouches for the copied material, the rendering system accepts the content material and renders, or continues to render, the material, at 390.

If the rendering system does not authorize the rendering, and the source system does not vouch for the authorization to render the material, the rendering system rejects the content material and does not render, or ceases to render, the material, at 380.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented in the context of vouching for an authorization when the routine authorization process fails, one of ordinary skill in the art will recognize that the vouching presented in this invention could be applied regardless of the state of the routine authorization process, to always require vouching and routine local authorization for extremely sensitive information. These and other system configuration and optimization features will be evident to one of ordinary skill in the art in view of this disclosure, and are included within the scope of the following claims.

1. A method of controlling rendering of a copy of content material, including:
querying a source of the copy of the content material to determine whether the copy is authorized for rendering, and
rendering the copy if the source confirms that the copy is authorized for rendering.

2. The method of claim 1, further including
determining whether the copy is authorized for rendering from information contained in the copy, and
querying the source only if the information in the copy indicates that the copy is not authorized.

3. The method of claim 2, wherein
the information contained in the copy includes watermark information.

4. The method of claim 1, wherein
the source confirms that the copy is authorized for rendering via a cryptographic process.

5. The method of claim 1, wherein
the source confirms that the copy is authorized by demonstrating that the source has access to an original of the content material from which the copy was created.

6. A method of controlling rendering of a copy of content material, including
receiving, at a source of the copy, a query from a remote device to vouch for an authorization to render the copy of the content material at a remote device,
communicating, from the source of the copy, the authorization to render the copy of the content material at the remote device.

7. The method of claim 6, further including
verifying, to the remote device, that the source of the copy is authentic.

8. The method of claim 6, further including
marking the content material with an identifier of the source of the copy.

9. The method of claim 6, further including
marking the content material with information that facilitates a verification of the source of the copy.

10. The method of claim 9, wherein
the information includes a cryptographic key.

11. The method of claim 6, wherein
the authorization to render the copy is communicated to the remote device by demonstrating that the source has access to an original copy of the content material from which the copy was created.

12. A rendering device comprising:
a rendering module that is configured to selectively render a copy of content material, and
a vouching module that is configured to:
query a source of the copy of the content material to determine whether the copy is authorized for rendering, and
enable the rendering module to render the copy if the source confirms that the copy is authorized for rendering.

13. The rendering device of claim 12, further including
an authorization module that is configured to
determine whether the copy is authorized for rendering from information contained in the copy, and
enable the rendering module to render the copy if the information in the copy indicates that the copy is authorized for rendering.

14. The rendering device of claim 13, wherein
the vouching module is operable coupled to the authorization module and only queries the source when the authorization module determines that the copy is not authorized for rendering.

15. The rendering device of claim 13, wherein
the information contained in the copy includes watermark information.

16. The rendering device of claim 12, wherein
the vouching module determines from the source whether the copy is authorized for rendering via a cryptographic process.

17. The rendering device of claim 12, wherein
the vouching module determines from the source whether the copy is authorized for rendering by verifying that the source has access to an original of the content material from which the copy was created.

18. A source device comprising:
a rendering module that is configured to provide a copy of content material, and
a vouching module that is configured to:
receive a query from a remote device, and
communicating an authorization to render the copy of the content material at the remote device.

19. The source device of claim 18, wherein
the vouching module is further configured to verify to the remote device that the source device created the copy of the content material.

20. The source device of claim 18, wherein
the rendering module is further configured to mark the content material with an identifier of the source device.

21. The source device of claim 18, wherein
the rendering module is further configured to mark the content material with information that facilitates a verification of the source device that rendered the copy.

22. The source device of claim 21, wherein
the information includes a cryptographic key.

23. The source device of claim 18, wherein
the authorization to render the copy is communicated to the remote device by demonstrating that the source device has access to an original copy of the content material from which the copy was created.
